(19) United States
(12) Patent Application Publication
(10) Pub. No.: US 2005/0099026 A1
(43) Pub. Date: May 12, 2005

(54) Vehicle door protector

(76) Inventor: Julian Velazquez, Wilmington, DE (US)

Correspondence Address: LITMAN LAW OFFICES, LTD., P.O. BOX 15035 CRYSTAL CITY STATION, ARLINGTON, VA, 22215, US

(21) Appl. No.: 10/703,489

(22) Filed: Nov. 10, 2003

(51) Int. Cl. B60R 19/42

(52) U.S. Cl. 293/128

(57) ABSTRACT

The vehicle door protector is provided in the form of an elongated lightweight tubular bar of PVC having a length that coincides with the width of a vehicle's door or door and fender. The bar includes a pair of PVC end caps closing the ends of the bar and equally space apertures along the length of the bar for mounting suction cups to the bar. The suction cups are used to secure the vehicle door protector to the vehicle. One end of a galvanized steel cable is attached to one end cap of the bar. The second end of the cable is formed into a loop for attachment to a hook, door handle, or other object etc in the interior of a locked vehicle to prevent theft of the door protector.

### BACKGROUND OF THE INVENTION

1. Field of the Invention

The present invention relates to vehicle body protectors and more particularly to a vehicle door protector.

2. Description of the Related Art

A problem encountered when parking vehicles in contemporary parking lots is that generally the space allotted for each vehicle is usually just enough for safe maneuvering of your vehicle into a spot. However, this amount of space doesn't leave very much room for fully opening a car door to exit. Add to that the poor parking skills of some drivers and it is easy to see why frequent usage of such parking lots causes vehicles to suffer numerous dings and dents upon the vehicle's finish caused by the impacts from doors being opened on nearby vehicles. Numerous devices have been made in the past for combating this problem, including the use of portable protective such as those set forth below.

In U.S. Pat. No. 4,828,303 issued May 9, 1989 to Soria an automobile body protection apparatus in the form of a telescopic elongate bar assembly for adjusting the length of the apparatus for mounting on any size of automobile. The bar assembly includes slideable suction cups for connecting the apparatus to an automobile. A rubber strap having a bar at one end is attached at the other end to the rubber coating on the largest telescopic bar. With all the sliding and adjustable elements in Soria, attaching the device to the automobile can be an awkward and time-consuming task.

In U.K. Patent Application 2 282 718 A, published Mar. 15, 1995 to Lendrum a vehicle body protector is taught in the form of an inflatable polyvinylchloride (PVC) tube with a valve. The valve is used for inflating the tube for use upon a vehicle and deflating the tube for storage. A PVC strip with a stopping element at one end is attached to the tube for securing the protector on the vehicle. The weight and balance of the tube and strip keeps the bar in place upon a vehicle parked on a level surface. However, if a parking space were on an incline, gravity could cause misalignment of the inflatable protector upon the vehicle.

In U.S. Pat. No. 5,156,425 issued Oct. 20, 1992 to Wagner a resilient vehicle side bumper made of extruded cross-linked polyethylene with a cylindrical hollow inner core. The bumper has a forward portion and a rearward portion that are rotatably locked together by male and female portions of a connecting device. A plurality of magnets and suction cups on the bottom of the bumper secure the bumper to the side of the vehicle. Neoprene rubber locking devices attached to the bumper portions are inserted behind the door between the gap between the door and body to prevent the bumper from being detached from the vehicle after the door has been closed and locked. The resilient vehicle side bumper of Wagner requires significant machining to produce and the corresponding costs.

None of the above inventions and patents, taken either singly or in combination, is seen to describe the instant invention as claimed. Thus a vehicle door protector solving the aforementioned problems is desired.

### SUMMARY OF THE INVENTION

The vehicle door protector of the present invention is provided in the form of an elongated lightweight tubular bar of PVC having a length that coincides with the width of a vehicle's door or door and fender. The bar includes a pair of PVC end caps closing the ends of the bar and equally space apertures along the length of the bar for mounting suction cups to the bar. The suction cups are used to secure the vehicle door protector to the vehicle. One end of a galvanized steel cable is attached to one end cap of the bar. The second end of the cable is formed into a loop for attachment to a hook, door handle, or other object etc in the interior of a locked vehicle to prevent theft of the door protector.

Accordingly, it is a principal object of the invention to provide a vehicle door protector that is simple in construction and easily attached and detached from a vehicle door or door and fender.

It is another object of the invention to provide a vehicle door protector having a galvanized steel cable with a loop formed at one end to prevent theft of the device.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a vehicle door protector according to the present invention installed upon a vehicle.

FIG. 2 is a bottom view of the vehicle door protector of the present invention.

FIG. 3 is an exploded view of the vehicle door protector of the present invention.

FIG. 4 is a perspective view of one end of the anti-theft cable of the vehicle door protector of the present invention.

FIG. 5 is a cross-sectional view of an end cap with anti-theft cable attached according to the present invention.

Similar reference characters denote corresponding features consistently throughout the attached drawings.

### DETAILED DESCRIPTION OF THE PREFERRED EMBODIMENTS

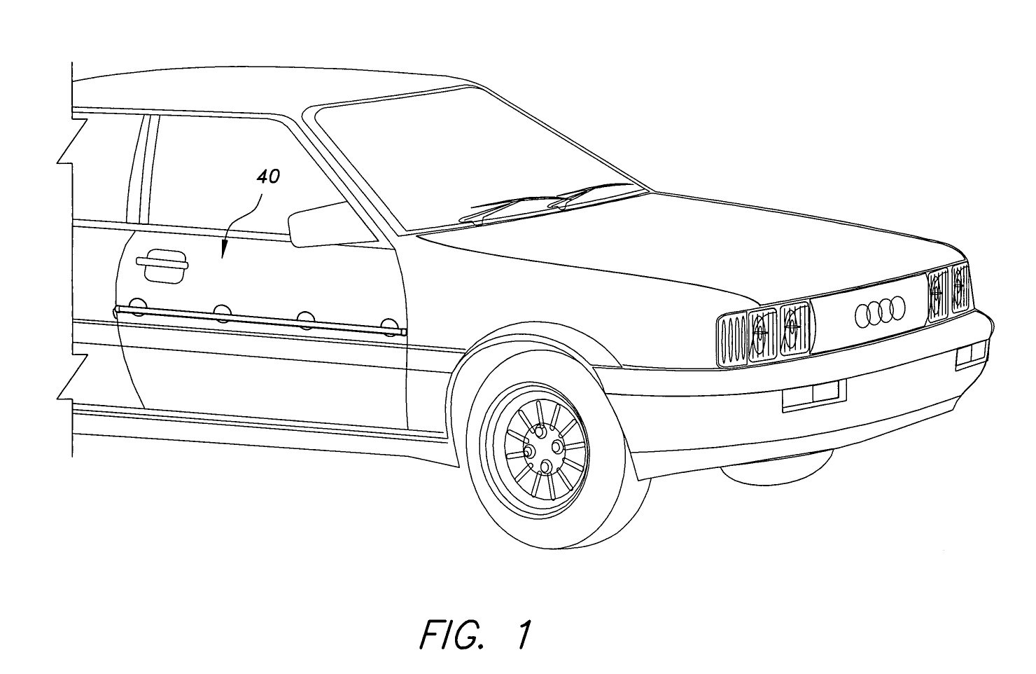

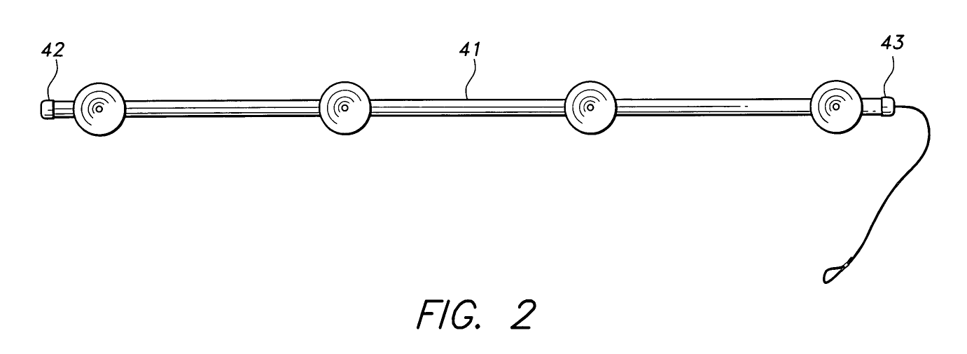

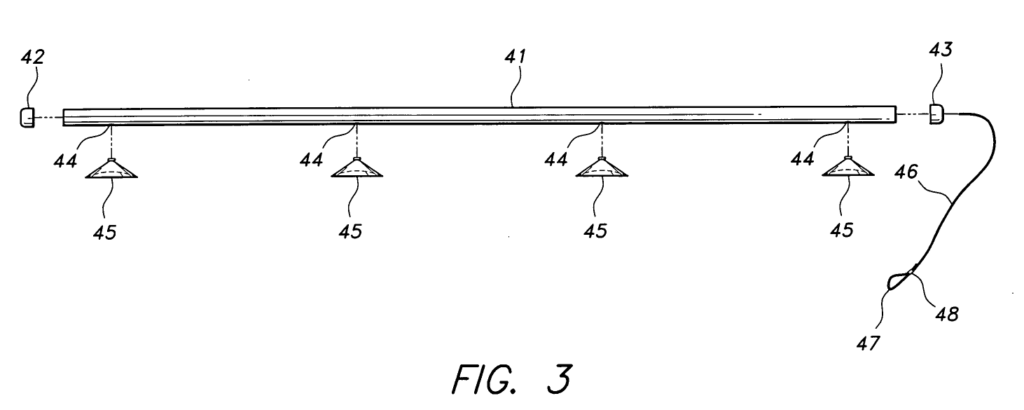

Referring to FIG. 1, the vehicle door protector 40 of the present invention is shown attached to a vehicle door and fender. FIGS. 2 and 3 show that door protector 40 is provided in the form of a flexible elongated lightweight tubular bar 41 of plastic material. Preferably tubular bar 41 is formed of PVC material with an outer diameter of three-quarters of an inch. The flexibility of the bar 41 allows it to fit the contour of any style of vehicle. The length of the bar 41 preferably coincides with the width of a vehicle's door but may be sized to cover the door and front fender as shown in FIG. 1.

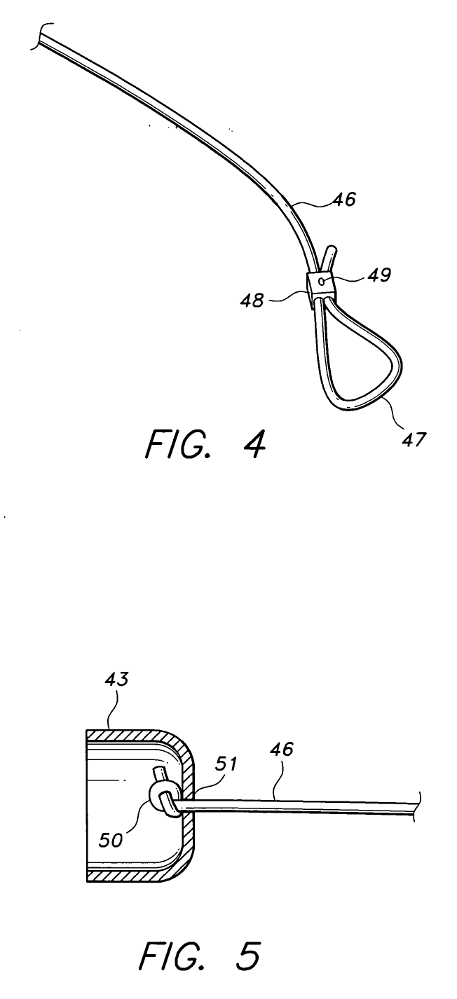

The bar 41 includes a plastic cap 42 adhesively secured on one end and a second cap 43 adhesively secured on a second end. The caps are also preferably formed from PVC material. End cap 43, as best seen in FIGS. 2 and 5 has one end of a flexible three-sixteenth inch galvanized steel cable 46 passing through an aperture 51 into end cap 43. The end is formed into a knot 50 that is too large to be removed through aperture 51. The other end of cable 46 is formed into a loop 47 and secured within a tubular lock nut 48 by a setscrew 49 as best seen in FIG. 4. The loop 47 of the cable 46 can be attached to a hook, door handle, seat lever or other object in the interior of a locked vehicle to prevent theft of the door protector 40.

To secure the vehicle door protector 40 onto a vehicle door, apertures 44 are provided equally spaced along the length of bar 41. Each aperture 44 receives the head of a suction cup 45 to secure the vehicle door protector 40 to the vehicle. The flexibility of the bar 41 and the compressibility of the suction cups 45 allow the vehicle door protector 40 to absorb the impact of opened doors to protect both vehicles from damage.

The end caps 42, 43 and bar 41 are painted to match the vehicle's finish to provide a more aesthetic appearance to the vehicle when the door protector 40 is affixed. To apply the vehicle door protector 40 to a vehicle one just has to secure the loop 47 to an object in the vehicle, close the door and attach the vehicle door protector 40 to the door in an appropriate location using suction cups 45.

It is to be understood that the present invention is not limited to the embodiments described above, but encompasses any and all embodiments within the scope of the following claims.

1. A vehicle door protector, comprising:
a flexible elongated lightweight tubular bar of PVC material having a first end and a second end;
said bar having a length of that coincides with the width of a vehicle's door;
a pair of PVC end caps secured to said first and second ends of said bar;
means for removably attaching said door protector to a vehicle door; and
means for preventing theft of said door protector.

2. The vehicle door protector according to claim 1, wherein said means for removably attaching said door protector comprises
a number of equal space apertures along the length of said bar; and
a suction cup received in each said aperture.

3. The vehicle door protector of claim 2, wherein said means for preventing theft comprises:
a flexible cable having one end passing through an aperture into one end cap and a second end formed into a loop.

4. The vehicle door protector of claim 3, wherein said cable is a flexible three-sixteenth inch galvanized steel cable.

5. The vehicle door protector of claim 4, wherein said loop is held by a lock nut having a setscrew.

6. A vehicle door protector, comprising:
an elongated lightweight tubular bar of plastic material having a first end and a second end and an outer diameter of three-quarters of an inch, said bar having a that allows the bar to flex to fit the contour of any style of vehicle;
said bar having a length of that coincides with the width of a vehicle's door;
means for removably attaching said door protector to a vehicle door; and
means for preventing theft of said door protector.

7. The vehicle door protector according to claim 6, wherein said means for removably attaching said door protector comprises
a number of equal space apertures along the length of said bar; and
a suction cup received in each said aperture.

8. The vehicle door protector of claim 6, wherein said means for preventing theft comprises:
a cable attached to said bar at one end and formed into a loop at a second end.

9. The vehicle door protector of claim 8, wherein said cable is a flexible three-sixteenth inch galvanized steel cable.

10. The vehicle door protector of claim 9, wherein a locknut having a setscrew holds said loop together.

11. The vehicle door protector according to claim 6, further including a pair of plastic end caps secured to said first and second ends of said bar.

12. The vehicle door protector of claim 11, wherein said means for preventing theft comprises:
a cable having one end passing through an aperture into one end cap and a second end formed into a loop.

13. The vehicle door protector of claim 12, wherein said cable is a flexible three-sixteenth inch galvanized steel cable.

14. The vehicle door protector of claim 12, wherein a locknut having a setscrew holds said loop together.

15. A vehicle door protector, comprising:
an elongated lightweight tubular bar of plastic material having a first end and a second end and an outer diameter of three-quarters of an inch, said bar having a that allows the bar to flex to fit the contour of any style of vehicle;
said bar having a length of that coincides with the width of a vehicle's door;
means for removably attaching said door protector to a vehicle door; and
means for preventing theft of said door protector;
wherein said means for removably attaching said door protector comprises a number of equal space apertures along the length of said bar; and
a suction cup received in each said aperture.

16. The vehicle door protector of claim 15, wherein said plastic material is PVC material.

17. The vehicle door protector according to claim 16, further including a pair of plastic end caps secured to said first and second ends of said bar.

18. The vehicle door protector of claim 17, wherein said means for preventing theft comprises:
a cable having one end passing through an aperture into one end cap and a second end formed into a loop.

19. The vehicle door protector of claim 18, wherein said cable is a flexible three-sixteenth inch galvanized steel cable.

20. The vehicle door protector of claim 19, wherein a locknut having a setscrew holds said loop together.
